(19) United States
(12) Patent Application Publication
(10) Pub. No.: US 2026/0011907 A1
(43) Pub. Date: Jan. 8, 2026

(54) ELECTRONIC DEVICE

(71) Applicant: PEGATRON CORPORATION, TAIPEI CITY (TW)

(72) Inventors: Chao-Hsu Wu, Taipei City (TW); Shih-Keng Huang, Taipei City (TW); Chih-Wei Liao, Taipei City (TW); Hao-Hsiang Yang, Taipei City (TW); Chi-Yin Fang, Taipei City (TW); Chia-Hung Chen, Taipei City (TW); Hau Yuen Tan, Taipei City (TW)

(73) Assignee: PEGATRON CORPORATION, TAIPEI CITY (TW)

(21) Appl. No.: 19/176,041

(22) Filed: Apr. 10, 2025

(30) Foreign Application Priority Data
Jul. 8, 2024 (TW) 113125442

(51) Int. Cl. H01Q 1/22; H01Q 1/48; H01Q 21/30

(52) U.S. Cl. CPC H01Q 1/2266; H01Q 1/48; H01Q 21/30; H01Q 1/2291

(57) ABSTRACT

An electronic device includes a metal sidewall and an antenna module. The antenna module includes a feeding point, first and second antenna radiating bodies, a grounding radiating body, and two first lapping conductors. A first segment of the first antenna radiating body extends from the feeding point and second and third segments extend from the first segment along opposite directions. The feeding point and, the first and the second segments resonate a low frequency band. The feeding point and the first and the third segments resonate a first high frequency band. The grounding radiating body, the two first lapping conductors, and the metal sidewall enclose a closed slot and resonate a second high frequency band at the edge of the closed slot.

### CROSS-REFERENCE TO RELATED APPLICATION

This application claims the priority benefit of Taiwan application serial no. 113125442, filed on Jul. 8, 2024. The entirety of the above-mentioned patent application is hereby incorporated by reference herein and made a part of this specification.

### BACKGROUND

### Technical Field

The disclosure relates to an electronic device, and particularly relates to an electronic device with an antenna module having a small volume, wide bandwidth, and good antenna performance.

### Related Art

As the bezels of tablet devices or laptops with all-metal back covers become increasingly narrow, the space available for placing antennas within the devices is also becoming smaller. Accordingly, characteristics of wide bandwidth and antenna performance may deteriorate.

### SUMMARY

The disclosure provides an electronic device where antenna module has characteristics of small volume, wide bandwidth, and good antenna performance.

The electronic device of the disclosure includes a metal sidewall and an antenna module. The antenna module is disposed beside the metal sidewall and includes a feeding point, a first antenna radiating body, a second antenna radiating body, a grounding radiating body, and two first lapping conductors. The first antenna radiating body includes a first segment, a second segment, and a third segment. The first segment extends from the feeding point; the second segment and the third segment of the first antenna radiating body extend along an opposite direction from the first segment; the feeding point, the first segment, and the second segment resonate a low frequency band; the feeding point, the first segment, and the third segment resonate a first high frequency band. The second antenna radiating body extends from the feeding point. The grounding radiating body is connected with the second antenna radiating body and located beside the metal sidewall, and the second antenna radiating body is located between the third segment and the grounding radiating body. The two first lapping conductors are connected between the grounding radiating body and the metal sidewall. The grounding radiating body, the two first lapping conductors, and the metal sidewall enclose a closed slot and resonate a second high frequency band at the edge of the closed slot.

In an embodiment of the disclosure, the grounding radiating body may include a first portion near the second segment. A first slot may be formed between the first portion and the second segment, and the first slot may be equivalent to a parallel capacitor.

In an embodiment of the disclosure, the second antenna radiating body may have a plurality of bends to form a meandering path, and the meandering path may be equivalent to an LCL equivalent circuit, in which L is the series inductance and C is the parallel capacitance.

In an embodiment of the disclosure, a second slot may be formed between the second antenna radiating body and the first segment, and between the second antenna radiating body and the third segment, in which the second slot is equivalent to a parallel capacitor.

In an embodiment of the disclosure, the grounding radiating body may include a second portion near the second antenna radiating body, a third slot may be formed between the second antenna radiating body and the second portion, and the third slot may be equivalent to a parallel capacitor.

In an embodiment of the disclosure, the electronic device may further include a metal bottom plate and a metal wall. The metal bottom plate may be connected with the metal sidewall and the two first lapping conductors. The metal wall may be erected on the metal bottom plate. The metal sidewall, the metal bottom plate, and the metal wall may form an internal metal cavity, and the antenna module may be located in the internal metal cavity.

In an embodiment of the disclosure, the metal bottom plate may include an opening near the antenna module, and the length of the opening may be 0.35 to 0.4 times the wavelength of the low frequency band.

In an embodiment of the disclosure, the grounding radiating body may be connected to an internal metal layer through a second lapping conductor.

In an embodiment of the disclosure, the length of the edge of the closed slot may be 0.5 times the wavelength of the second high frequency band.

In an embodiment of the disclosure, the low frequency band may be in a range of 2412 MHz to 2472 MHz, the first high frequency band may be in a range of 5150 MHz to 5875 MHz, and the second high frequency band may be in a range of 5925 MHz to 7123 MHz.

Based on the above, the antenna module of the electronic device of the disclosure is disposed beside the metal sidewall and includes a feeding point, a first antenna radiating body, a second antenna radiating body, a grounding radiating body, and two first lapping conductors. The feeding point and the first segment and the second segment of the first antenna radiating body resonate a low frequency band; the feeding point and the first segment and the third segment of the first antenna radiating body resonate a first high frequency band; the grounding radiating body, the two first lapping conductors, and the metal sidewall resonate a second high frequency band.

Accordingly, the antenna module of the electronic device of the disclosure has characteristics of small volume, wide bandwidth, and good antenna performance.

### BRIEF DESCRIPTION OF THE DRAWINGS

FIG. 1 is a schematic diagram of an electronic device according to an embodiment of the disclosure;

FIG. 2 is a partially enlarged schematic diagram of an antenna module on right side of the electronic device in FIG. 1;

FIG. 3 is a cross-sectional view along a line A-A of the electronic device in FIG. 1;

FIG. 4 is a frequency-VSWR relationship diagram of the antenna module in FIG. 1;

FIG. 5 is a frequency-efficiency relationship diagram of the antenna module in FIG. 1;

FIG. 6 is a schematic diagram of an electronic device according to another embodiment of the disclosure;

FIG. 7 is a partially enlarged schematic diagram of the antenna module on the right side of the electronic device in FIG. 6; and

FIG. 8 is a cross-sectional view along a line B-B of the electronic device in FIG. 6.

### DESCRIPTION OF THE EMBODIMENTS

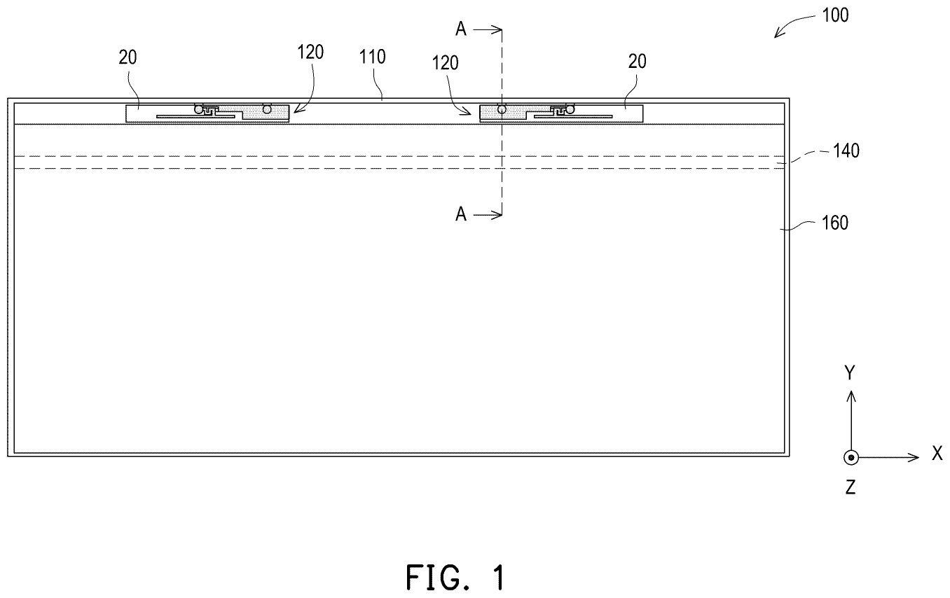

FIG. 1 is a schematic diagram of an electronic device according to an embodiment of the disclosure. For clarity in illustrating an antenna module 120, a coaxial transmission line 10 is not shown in FIG. 1. Please refer to FIG. 1. An electronic device 100 of this embodiment may be a tablet device or a laptop with an all-metal back cover. The electronic device 100 includes a metal sidewall 110 and two antenna modules 120. The two antenna modules 120 are disposed beside the metal sidewall 110 and disposed at a corresponding circuit board 20, respectively, and are symmetrically disposed on left and right sides of the electronic device 100.

In this embodiment, the antenna module 120 may resonate at a low frequency band, a first high frequency band, and a second high frequency band. The low frequency band is in a range of 2412 MHz to 2472 MHz; the first high frequency band is in a range of 5150 MHz to 5875 MHz; the second high frequency band is in a range of 5925 MHz to 7123 MHz. However, the frequency ranges of the low frequency band, the first high frequency band, and the second high frequency band are not limited to these ranges.

In this embodiment, the width of the antenna module 120 in an axial direction Y is 4 millimeters, and the distance between the antenna module 120 and the metal sidewall 110 is 0.5 millimeters. However, the width of the antenna module 120 in the axial direction Y and the position are not limited thereto. Furthermore, the size of the circuit board 20 is 50 millimeters×5 millimeters×0.6 millimeters, and the circuit board 20 is perpendicular to an axial direction Z. However, the size and orientation of the circuit board 20 are not limited thereto.

The structure of the antenna module 120 will be explained in detail below using the antenna module 120 on the right side in FIG. 1.

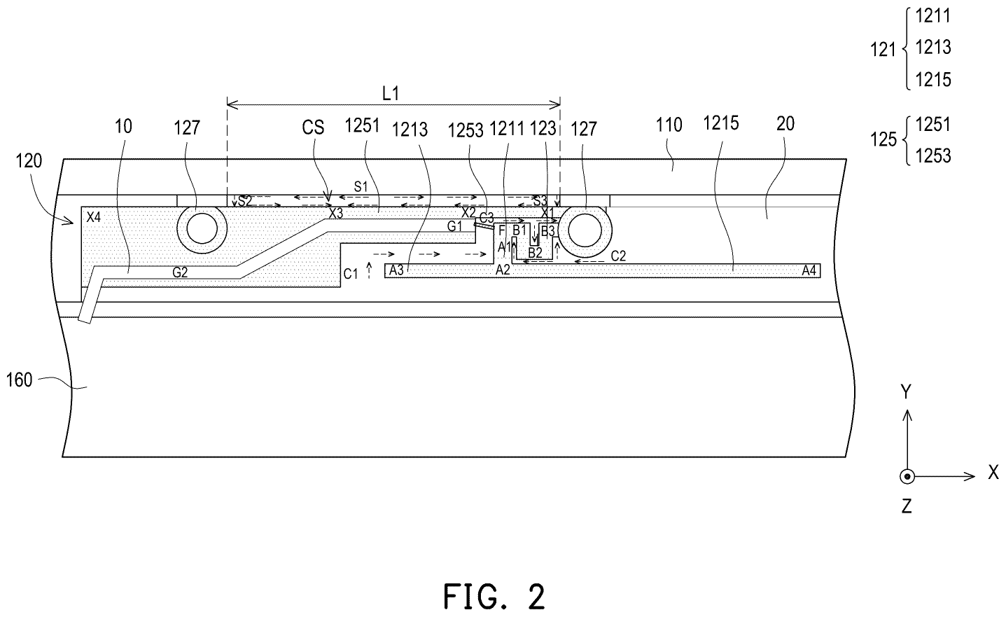

FIG. 2 is a partially enlarged schematic diagram of the antenna module on the right side of the electronic device in FIG. 1. Please refer to FIG. 2. The antenna module 120 includes a feeding point F, a first antenna radiating body 121 (the path area from a position A1 to a position A2, from the position A2 to a position A3, and from the position A2 to a position A4), a second antenna radiating body 123 (the path area from a position B1 sequentially to positions B2, B3), a grounding radiating body 125 (the path area from position X1 sequentially to positions X2, X3, X4), and two first lapping conductors 127. In this embodiment, the feeding point F is electrically connected with the positive signal terminal of the coaxial transmission line 10, and transmits signals to the first antenna radiating body 121 and the second antenna radiating body 123.

In detail, the first antenna radiating body 121 includes a first segment 1211 (the path area from the position A1 to the position A2), a second segment 1213 (the path area from the position A2 to the position A3), and a third segment 1215 (the path area from the position A2 to the position A4). The first segment 1211 extends from the feeding point F along the negative direction of the axial direction Y, while the second segment 1213 and the third segment 1215 extend from the first segment 1211 in opposite directions. In this embodiment, the second segment 1213 extends along the negative direction of an axial direction X, and the third segment 1215 extends along the positive direction of the axial direction X. However, the disclosure is not limited thereto. The second antenna radiating body 123 extends from the feeding point F and is located between the third segment 1215 and the grounding radiating body 125. The grounding radiating body 125 is connected with the second antenna radiating body 123 and located beside the metal sidewall 110.

The antenna module 120 resonates a low frequency band through the feeding point F, the first segment 1211, and the second segment 1213, and resonates a first high frequency band through the feeding point F, the first segment 1211, and the third segment 1215. In addition, in FIG. 2, the grounding radiating body 125, the two first lapping conductors 127, and the metal sidewall 110 enclose a closed slot CS (the path area from a position S1 sequentially to positions S2, X3, and the path area from the position S1 sequentially to positions S3, X3). The grounding radiating body 125, the two first lapping conductors 127, and the metal sidewall 110 resonate a second high frequency band at the edge of the closed slot CS.

In this embodiment, the closed slot CS may be in the shape of a horizontal straight line, and a length L1 of the edge of the closed slot CS is 0.5 wavelength of the second high frequency band. Specifically, the length L1 in this embodiment is designed to be 0.5 wavelength of the operating frequency of 6.8 GHz. That is, the length L1 is 21 millimeters. However, the shape of the closed slot CS and the size of the length L1 are not limited thereto.

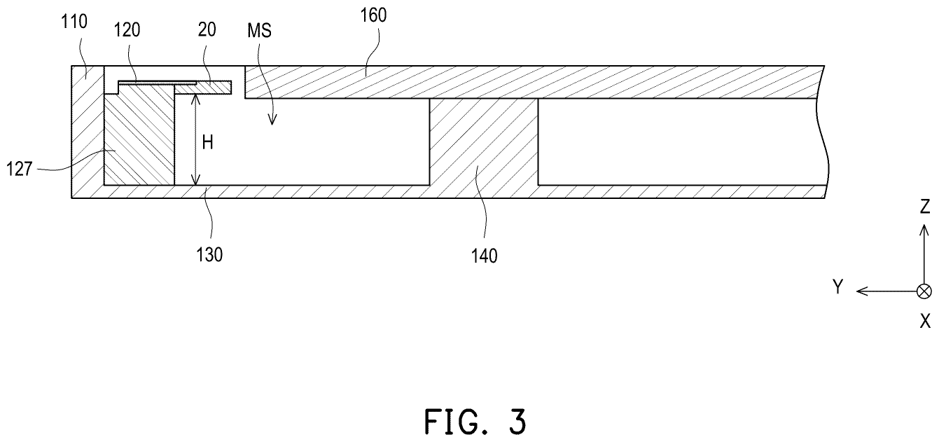

FIG. 3 is a cross-sectional view along a line A-A of the electronic device in FIG. 1. Please refer to FIG. 2 and FIG. 3. The two first lapping conductors 127 are connected between the grounding radiating body 125 and the metal sidewall 110, and the second antenna radiating body 123 is connected to the grounding radiating body 125 through the first lapping conductor 127 on the right side as shown in FIG. 2. In this embodiment, the two first lapping conductors 127 may be screw hole structures and be electrically connected to ground terminals G1 and G2. The ground terminals G1 and G2 are electrically connected to the negative signal terminal of the coaxial transmission line 10 thus to be electrically connect to the system ground plane. The antenna module 120 has a good grounding environment through the grounding configuration to ensure the stability of grounding of the antenna module 120 and avoid interference from the coaxial transmission line 10.

The structure of the electronic device 100 is described in detail below.

Please refer to FIG. 3. The electronic device 100 of this embodiment further includes a metal bottom plate 130, a metal wall 140, and an internal metal layer 160. The metal bottom plate 130 is connected with the metal sidewall 110 and the two first lapping conductors 127. The metal wall 140 is erected on the metal bottom plate 130. The internal metal layer 160 (such as a touch screen) is connected with the metal wall 140. The metal sidewall 110, the metal bottom plate 130, the metal wall 140, and a portion of the internal metal layer 160 form an internal metal cavity MS, and the antenna module 120 is located in the internal metal cavity MS. Through the configuration of the electronic device 100, the energy radiation direction of the antenna module 120 is allowed to be concentrated in the axial direction Z. In this embodiment, a height H from the circuit board 20 to the metal bottom plate 130 may be 5 millimeters, but the disclosure is not limited thereto.

The impedance matching circuit effect formed by the antenna module 120 is described in detail below.

Please refer to FIG. 2. The grounding radiating body 125 of this embodiment includes a first portion 1251 (the path area from the position X2 to the position X3) near the second segment 1213. A first slot C1 is formed between the first portion 1251 and the second segment 1213, and the first slot C1 is equivalent to a parallel capacitor. A second slot C2 is formed between the second antenna radiating body 123 and the first segment 1211, and between the second antenna radiating body 123 and the third segment 1215, in which the second slot C2 is equivalent to a parallel capacitor. The grounding radiating body 125 includes a second portion 1253 (the path area from the position X1 to position the X2) near the second antenna radiating body 123. A third slot C3 is formed between the second antenna radiating body 123 and the second portion 1253, and the third slot C3 is equivalent to a parallel capacitor. The second antenna radiating body 123 has a plurality of bends to form a meandering path, and the meandering path may be equivalent to an LCL equivalent circuit, in which L is the series inductance and C is the parallel capacitance. The second slot C2, the second antenna radiating body 123, and the third slot C3 are equivalent to a CLCLC impedance matching circuit effect.

In this embodiment, the first slot C1 may be L-shaped; the second slot C2 may be U-shaped; the third slot C3 may be T-shaped. However, the shapes of the first slot C1, the second slot C2, and the third slot C3 are not limited thereto.

It is worth noting that the antenna module 120 may adjust the impedance matching circuit effect of the antenna module 120 by adjusting the width and length of the first slot C1, the second slot C2, the third slot C3, and the second antenna radiating body 123, thereby adjusting the frequency position and impedance matching bandwidth of the low frequency and the first high frequency resonant bands. In addition, through the disposition of the first slot C1, the second slot C2, the third slot C3, and the second antenna radiating body 123, the antenna module 120 can achieve the effect of a capacitive-inductive matching circuit in a limited space without the additional capacitors and inductors, thus achieving the effects of space-saving and cost-saving.

Table 1 is a comparison table of the frequency, channel, average transmit power, and 1 g SAR test value of the antenna module. Please refer to Table 1. The average transmit power for WiFi 2.4G may be above 16.5 dBm; the average transmit power for WiFi 5G may be above 15.5 dBm; the average transmit power for WiFi 6G may be above 12.3 dBm. Additionally, the 1 g SAR test values of the electronic device 100 may all meet the FCC specification requirement of 1 g SAR<1.6 W/kg. Accordingly, the electronic device 100 has the characteristics of high transmit power and low SAR values.

TABLE 1
Comparison table of the frequency, channel, average transmit
power, and 1 g SAR test value of the antenna module

| | | | Average transmit | |
|---|---|---|---|---|
| | Frequency | | power | 1 g SAR test value |
| | (MHz) | Channel | (dBm) | (W/Kg) |
| WiFi 2.4G | 2412 | 1 | 16.5 | 0.80 |
| | 2437 | 6 | 16.5 | 0.81 |
| | 2462 | 11 | 16.5 | 0.85 |
| WiFi 5G | 5260 | 52 | 18.0 | 0.85 |
| | 5270 | 54 | 18.0 | 0.88 |
| | 5530 | 106 | 15.5 | 0.34 |
| | 5610 | 122 | 15.5 | 0.77 |
| | 5690 | 138 | 15.5 | 0.80 |
| | 5755 | 151 | 16.0 | 0.90 |
| | 5775 | 155 | 16.0 | 0.85 |
| | 5815 | 163 | 16.0 | 0.66 |
| | 5855 | 171 | 16.0 | 0.85 |
| WiFi 6G | 6025 | 15 | 13.0 | 0.41 |
| | 6185 | 47 | 13.0 | 0.42 |
| | 6505 | 111 | 13.0 | 0.40 |
| | 6825 | 175 | 12.3 | 0.28 |
| | 6985 | 207 | 12.3 | 0.28 |

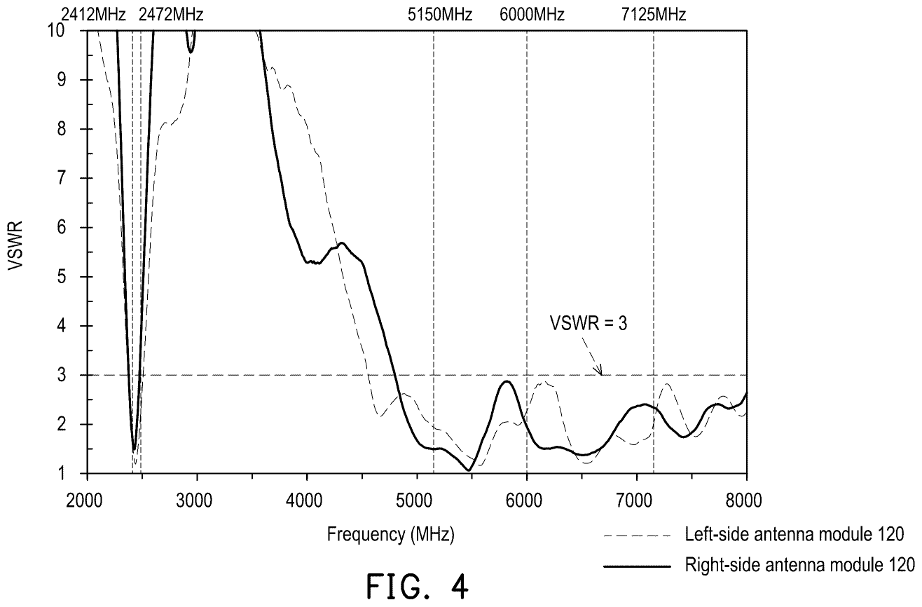

FIG. 4 is a frequency-VSWR relationship diagram of the antenna module in FIG. 1. Please refer to FIG. 4. In this embodiment, when the Y-axis length of the antenna module 120 is 4 millimeters, the VSWR of the antenna module 120 is all below 3, exhibiting good performance.

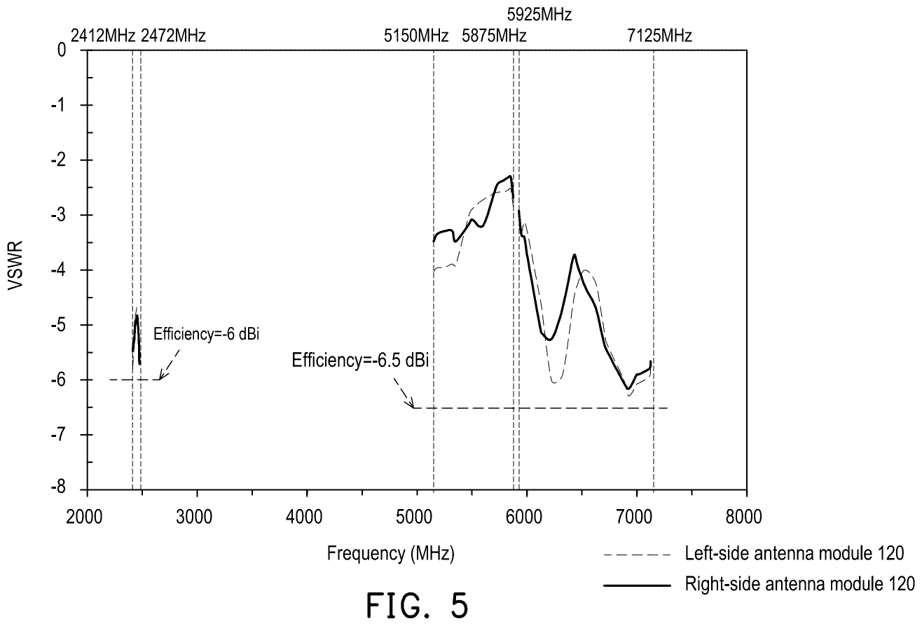

FIG. 5 is a frequency-efficiency relationship diagram of the antenna module in FIG. 1. Please refer to FIG. 5. In this embodiment, when the Y-axis length of the antenna module 120 is 4 millimeters, the efficiency of the antenna module 120 in the low frequency band is −4.4 to −5.8 dBi, and the efficiency in the first high frequency band and the second high frequency band is −2.3 to −6.3 dBi. Accordingly, the antenna module 120 exhibits good antenna efficiency performance.

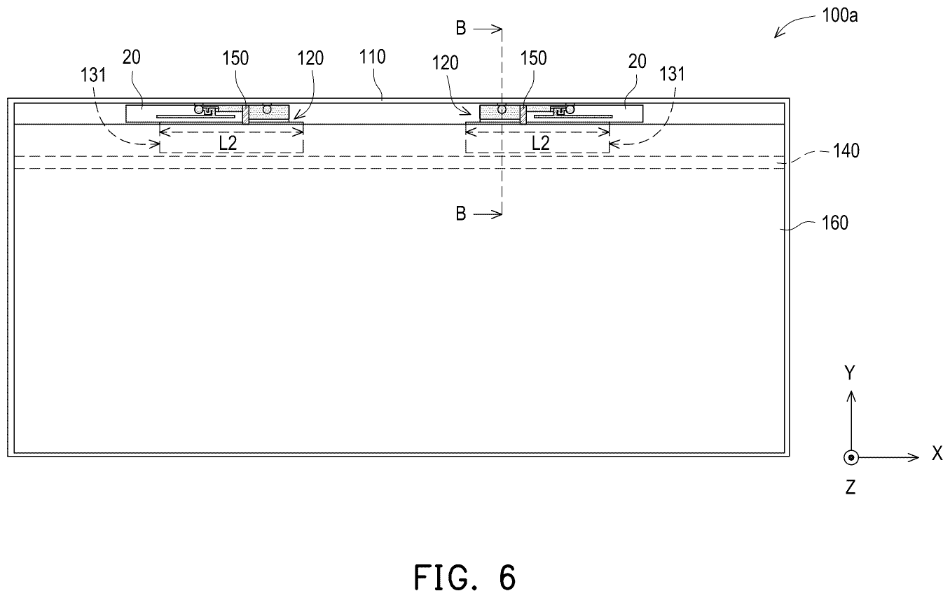

FIG. 6 is a schematic diagram of the electronic device according to another embodiment of the disclosure. The main difference between an electronic device 100a of this embodiment and the electronic device 100 of the foregoing embodiments is that a metal bottom plate 130a of the electronic device 100a in this embodiment includes two openings 131 near the two antenna modules 120, and each grounding radiating body 125 is connected to the internal metal layer 160 through a second lapping conductor 150. In this embodiment, a length L2 of each opening 131 is 0.35 to 0.4 times the wavelength of the low frequency band. The electronic device 100a may enhance the low frequency antenna performance of the antenna module 120 through the opening 131. In this embodiment, the size of the opening 131 may be 45 millimeters×10 millimeters, i.e. the length L2 of 45 millimeters. However, the sizes of the opening 131 and the length L2 are not limited thereto.

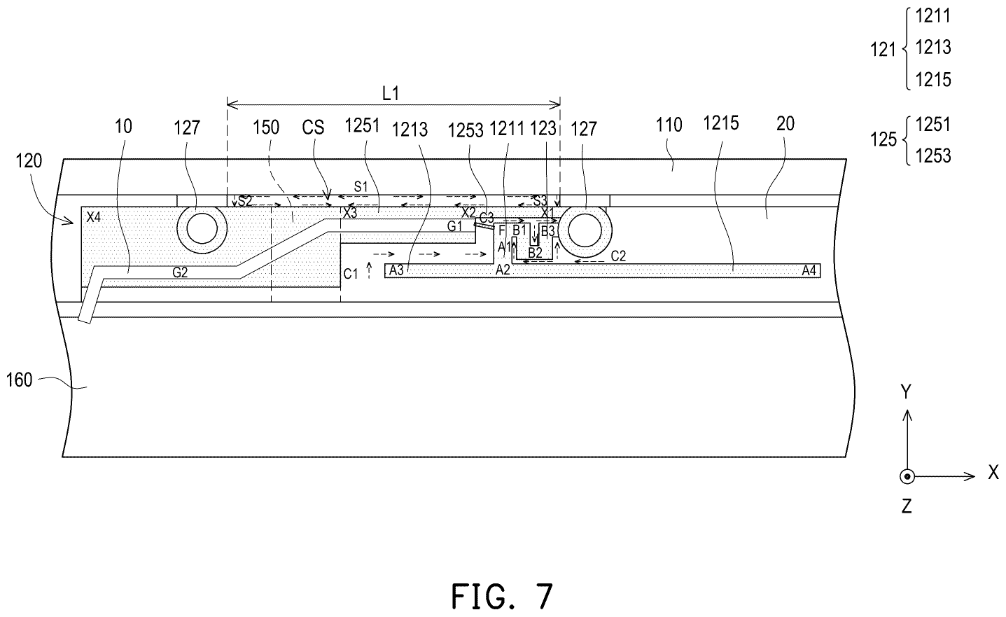

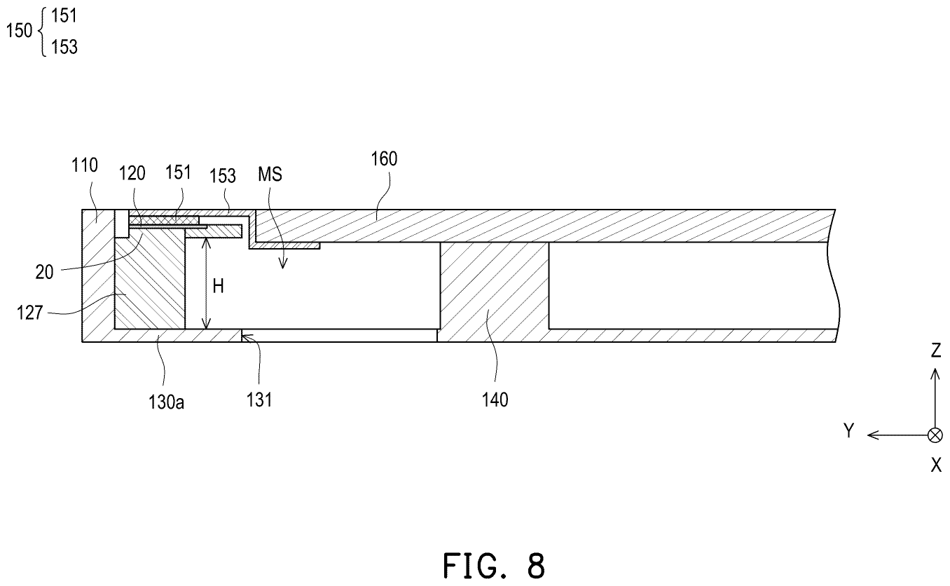

FIG. 7 is a partial enlarged schematic diagram of the antenna module on the right side of the electronic device in FIG. 6. FIG. 8 is a cross-sectional view along a line B-B of the electronic device in FIG. 6. For clarity in illustrating the antenna module 120, the second lapping conductor 150 in FIG. 7 is shown in perspective. Please refer to FIG. 7 and FIG. 8. The second lapping conductor 150 includes a conductive foam 151 and a conductive fabric 153. The conductive foam 151 is disposed between the antenna module 120 and the conductive fabric 153, and the conductive fabric 153 is connected to the internal metal layer 160. The electronic device 100a may further increase the grounding stability of the antenna module 120 by connecting the second lapping conductor 150 with the internal metal layer 160, thereby enhancing the antenna performance of the antenna module 120 and reducing the peak gain. In this embodiment, the size of the conductive foam 151 is 8 millimeters×4 millimeters, and the size of the conductive fabric 153 is 8 millimeters×15 millimeters, but the sizes of the conductive foam 151 and the conductive fabric 153 are not limited thereto.

In summary, the antenna module of the electronic device in the embodiments of the disclosure is disposed beside the metal sidewall and includes a feeding point, a first antenna radiating body, a second antenna radiating body, a grounding radiating body, and two first lapping conductors. The feeding point and the first segment and the second segment of the first antenna radiating body resonate a low frequency band, the feeding point and the first segment and the third segment of the first antenna radiating body resonate a first high frequency band, and the grounding radiating body, the two first lapping conductors, and the metal sidewall resonate a second high frequency band. Accordingly, the antenna module of the electronic device of the disclosure has characteristics of small volume, wide bandwidth, and good antenna performance. In an embodiment, the electronic device further includes openings, further enhancing the antenna performance of the antenna module in the low frequency band, and the electronic device also further enhances the grounding stability of the antenna module through the second lapping conductor.

What is claimed is:

1. An electronic device, comprising:
a metal sidewall; and
an antenna module disposed beside the metal sidewall and including:
a feeding point;
a first antenna radiating body including a first segment, a second segment, and a third segment, wherein the first segment extends from the feeding point, the second segment and the third segment extend from the first segment in opposite directions, the feeding point, the first segment, and the second segment resonate a low frequency band, and the feeding point, the first segment, and the third segment resonate a first high frequency band;
a second antenna radiating body extending from the feeding point;
a grounding radiating body connected with the second antenna radiating body and located beside the metal sidewall, wherein the second antenna radiating body is located between the third segment and the grounding radiating body; and
two first lapping conductors connected between the grounding radiating body and the metal sidewall, wherein the grounding radiating body, the two first lapping conductors, and the metal sidewall enclose a closed slot and resonate a second high frequency band at an edge of the closed slot.

2. The electronic device as claimed in claim 1, wherein the grounding radiating body comprises a first portion near the second segment, a first slot is formed between the first portion and the second segment, and the first slot is equivalent to a parallel capacitor.

3. The electronic device as claimed in claim 1, wherein the second antenna radiating body has a plurality of bends to form a meandering path, the meandering path is equivalent to an LCL equivalent circuit, and L is a series inductance and C is a parallel capacitance.

4. The electronic device as claimed in claim 3, wherein a second slot is formed between the second antenna radiating body and the first segment, and between the second antenna radiating body and the third segment, and the second slot is equivalent to a parallel capacitor.

5. The electronic device as claimed in claim 3, wherein the grounding radiating body comprises a second portion near the second antenna radiating body, a third slot is formed between the second antenna radiating body and the second portion, and the third slot is equivalent to a parallel capacitor.

6. The electronic device as claimed in claim 1, further comprising:
a metal bottom plate connected with the metal sidewall and the two first lapping conductors; and
a metal wall erected on the metal bottom plate, wherein the metal sidewall, the metal bottom plate, and the metal wall form an internal metal cavity, and the antenna module is located in the internal metal cavity.

7. The electronic device as claimed in claim 6, wherein the metal bottom plate comprises an opening near the antenna module, and a length of the opening is 0.35 to 0.4 times a wavelength of the low frequency band.

8. The electronic device as claimed in claim 1, wherein the grounding radiating body is connected to an internal metal layer through a second lapping conductor.

9. The electronic device as claimed in claim 1, wherein a length of the edge of the closed slot is 0.5 times a wavelength of the second high frequency band.

10. The electronic device as claimed in claim 1, wherein the low frequency band is in a range of 2412 MHz to 2472 MHz, the first high frequency band is in a range of 5150 MHz to 5875 MHz, and the second high frequency band is in a range of 5925 MHz to 7123 MHz.
